(19) United States
(12) Patent Application Publication
(10) Pub. No.: US 2012/0309866 A1
(43) Pub. Date: Dec. 6, 2012

(54) SOLDER INK AND ELECTRONIC DEVICE PACKAGE USING SAME

(75) Inventors: Yong Un Jang, Ulsan (KR); Sung Chul Kim, Suwon (KR); Yong Cheol Chu, Ulsan (KR); Seung Jun Jang, Ulsan (KR); Yoon Sang Son, Busan (KR)

(73) Assignee: DUK SAN TEKOPIA CO., LTD., Ulsan (KR)

(21) Appl. No.: 13/579,521

(22) PCT Filed: Mar. 10, 2010
(86) PCT No.: PCT/KR10/01491

§ 371 Date: Aug. 16, 2012

(30) Foreign Application Priority Data
Feb. 17, 2010 (KR) 10-2010-0014281

(51) Int. Cl. C09D 11/10; C08K 13/02

(52) U.S. Cl. 523/160; 524/270; 524/104; 524/265

(57) ABSTRACT

The present invention relates to a solder ink and an electronic device package using the same. The solder ink includes: a solder powder including an alloy including tin (Sn); a binder including a first resin comprising rosin resin or rosin modified resin; an active agent; and a solvent.

### TECHNICAL FIELD

The present invention relates to a solder ink and an electronic device package using the same. More particularly, the present invention relates to a solder ink being able to be applied to a continuous printing process and an electronic device package using the same.

### BACKGROUND ART

In a next generation electronic device, degree of precision of several-tens-micrometers is required in a large area and mass production should be possible with a low price. In order to achieve the same, a vibrant research for manufacturing an electronic device is being carried out. In the research, by applying all kinds of continuous printing processes (such as a roll screen printing method, a gravure printing method, a flexo printing method, a pad printing method, an inkjet printing method, an offset printing method, a gravure offset printing method) to a substrate that is supplied, a conductive material, a semiconductor material, and an insulating material are continuously printed to be suitable for their properties.

So as to apply the continuous printing method to an electronic device, two techniques (that is, electronic inks such as conductive ink or conductive polymer and printing apparatuses) should be secured. For the electronic ink, an ink of a liquid solution is manufacturing by a relative simple method at room temperature in order to be widely applied to a printing process. For example, the ink of the liquid solution is manufactured by using metal powders, organic polymer, an inorganic nano particle material and by adjusting viscosity and rheology property to be suitable for the printing. Some inks of this type are already in use.

However, there was no attempt that this continuous printing process is applied to form a packaging solder of an electronic device. In order to be applied to a packaging of an electronic device having high-density and high-speed, and becoming thin, fine pitch of less than 100 μm that is a limit of the conventional solder paste and mass production should be possible. Since a solder powder has specific gravity much larger than general fillers, manufacturing a solder ink having suitable soldering property and printing property is considered impossible.

On the other hand, an electronic device package is sealed so that an integrated circuit chip thereof can be mounted on and used for electronic equipment. The electronic device package includes a substrate being connected to the chip (generally, by bonding or flip chip type bonding) and having an wire therein, a molding for surrounding the chip, and a solder bump electrically connected to the wiring of the substrate.

### DISCLOSURE

### Technical Problem

The present invention according to an aspect is directed to provide a solder ink being able to be applied to a continuous printing process by securing soldering property and printing property.

Also, the present invention according to another aspect is directed to provide an electronic device package using a solder ink.

### Technical Solution

The present invention according to an aspect provides a solder ink is printed by a continuous printing method. Ths solder ink includes:

a solder powder including an alloy including tin (Sn);

a binder including a first resin including rosin resin or rosin modified resin;

an active agent; and

a solvent.

Here, the first resin may include at least one material selected from the group consisting of gum rosin, rosin esters, polymerized rosin esters, hydrogenated rosin esters, disproportionated rosin esters, dibasic acid modified rosin esters, rosin modified phenol resin, phenol modified rosin esters, terpenephenolic copolymer resin, maleic anhydride modified resin, and hydrogenated acryl modified resin.

Also, the binder may further include a second resin including at least one material selected from the group consisting of urethane based resin, acryl based resin, phenol based resin, vinyl based resin, cellulose base resin, alkyd based resin, ester based resin, and a polymer thereof.

In addition, the active agent may include at least one material selected from the group consisting of a lauric acid, memtetrahydrophthalic anhydride, a succinic acid, an adipic acid, a palmitic acid, a 3-boronfluoride ethyl amide complex, butylamine hydrobromide, butylamine hydrochloride, ethylamine hydrobromide, pyridine hydrobromide, cyclohexylamine hydrobromide, ethylamine hydrochloride, 1,3-diphenyl guanidine hydrobromide, 2,2-bishydroxymethyl propionic acid salt, and 2,3-dibromo-1-propanol.

Further, the solder ink may further include a thixotropic agent. The thixotropic agent may include at least one material selected from the group consisting of hydrogenated cast wax, polyamide wax, polyolefin wax, a dimer acid, a monomer acid, polyester modified polydimethyl siloxane, a polyaminamide carboxylic acid salt, carnauba wax, colloidal silica, and a bentonite-based clay.

Also, the solvent may include at least one material selected from the group consisting of clycidyl ethers, glycol ethers, vegetable oil, alpha-terpineol, and N-methyl-2-pyrrolidone(NMP).

In addition, the solder ink may further include a curing agent, a tackifier, and a thickening agent.

Further, the first resin may include rosin modified phenol resin.

Also, the second resin may include polyester polyol.

In addition, the solder powder has a melting point of 130˜300° C.

Further, the solder powder may include the alloy including the Sn and at least one material selected from the group consisting of Ag, Cu, Bi, Zn, In, and Pb.

Also, the solder powder may be included by 70˜90 wt %, the binder may be included by 3˜10 wt %, and the solvent may be included by 4˜12 wt %.

In addition, the weight ratio of the first resin of the binder:the second resin of the binder may be 50˜70:30˜50.

Further, the solder powder may have a particle size of 0.2 μm˜50 μm.

Also, the solder ink may be used in a roll-to-roll process where a flexible substrate is continuously supplied. The roll-to-roll process may use one or more of a roll screen printing method, a gravure printing method, a flexo printing method, an inkjet printing, an offset printing method, and a gravure offset printing method.

In addition, the solder ink may have a viscosity of 30˜200 Kcps.

Further, the solder ink may be printed on a metal, a glass, a plastic, a flexible printed circuit board, or a silicon wafer.

The present invention according to another aspect provides an electronic device package using a solder bump manufactured by using the solder ink.

Here, the electronic device package may be a chip size package or a wafer level package.

The present invention according to yet another aspect provides an electronic apparatus including the electronic device package.

Here, the electronic apparatus may be one apparatus selected from the group consisting of a liquid crystal display panel, a plasma display panel, a touch screen, a flexible liquid crystal display panel, a flexible organic light emitting diode panel, a solar cell, a radio frequency identification, a flexible conductive film, a polymer transistor, and an electronic book.

### Advantageous Effects

Soldering using a solder ink of an aspect of the present invention can be performed by a continuous printing process. Accordingly, compared with the convention method that a solder bump is formed by coating a solder paste, degree of precision can be high and finer pitch of an electronic device can be achieved. Mass production can be possible, and production cost can be reduced.

Also, the solder ink according to the present invention can be applied to a continuous printing on a metal, a glass, a plastic, a flexible printed circuit board, or a silicon wafer. Particularly, the solder ink can be used in a roll-to-roll process that a flexible substrate is continuously supplied.

Further, a solder bump manufactured using the solder ink according to the present invention can be usefully applied to a packaging an electronic device. Particularly, the solder bump can be used for a chip size package or a wafer level package.

In addition, an electronic device including the solder bump manufactured using the solder ink according to the present invention is included in various electronic apparatus. The electronic apparatus may be a liquid crystal display panel, a plasma display panel, a touch screen, a flexible liquid crystal display panel, a flexible organic light emitting diode panel, a solar cell, a radio frequency identification, a flexible conductive film, a polymer transistor, an electronic book, and so on.

### BRIEF DESCRIPTION OF DRAWINGS

FIG. 1 is a diagram for illustrating a printing method of a solder ink according to an embodiment of the present invention.

FIG. 2 is an enlarged photograph of a printed pattern according to an embodiment of the present invention.

FIG. 3 is a three-dimensional photograph of the printed pattern of FIG. 2.

### DETAILED DESCRIPTION OF THE EMBODIMENTS

A solder ink according to an aspect of the present invention includes a solder powder and a binder. In the descriptions, the solder ink includes a solder powder, and can be printed by a continuous printing method so that it can be used for a solder for mounting various electronic devices.

For the solder powder, a solder powder including tin (Sn) and further including at least one material of Ag, Cu, Bi, Zn, In, and Pb may be used. That is, a Sn—Ag based alloy, a Sn—Ag—Cu based alloy, a Sn—Cu based alloy, a Sn—Bi based alloy, a Sn—Zn based alloy, a Sn—Pb based alloy, and so on may be used.

Particularly, Sn-3.0Ag-0.5Cu(SAC305), Sn95.5-Ag3.9-Cu0.6, Sn-3.9Ag-0.6Cu, Sn-25Ag-10Sb, Sn-0.7Cu, Sn-3.5Ag, Sn-25g, Sn-2.8Ag-20In, Sn-55b, Sn-58Bi, Sn-9Zn, Sn-0.5Ag-4Cu, Sn-2Ag-0.75Cu, Sn-3.2Ag-0.5Cu, Sn-3.8Ag-0.7Cu, Sn-4Ag-0.5Cu, Sn-4Ag-1Cu, Sn-4.7Ag-1.7Cu, Sn-8Zn-3Bi, Sn-0.2Ag-2Cu-0.8Sb, Sn-2.5Ag-0.8Cu-0.5Sb(Castin), Sn-2Ag-7.5Bi, Sn-3.4Ag-4.8Bi, Sn-3.5Ag-3Bi, Sn-2Ag-3Bi-0.75Cu, Sn-3.5Ag-5Bi-0.7Cu, Sn-2Ag-4Bi-0.5Cu-0.1Ge, Sn-57Bi-0.1Ag, Sn-52In, Sn-2Ag, Sn-2.8Ag-20In, and so on may be used. Preferably, the Sn-3.0Ag-0.5Cu(SAC305), the Sn95.5-Ag3.9-Cu0.6, or the Sn—Bi based alloy may be used.

Specifically, the Sn-3.0Ag-0.5 Cu has enhanced properties (all propertied such as wettability and mechanical properties), compared with other lead-free alloys.

The solder powder may have a melting point of 130˜300° C., preferably, 175˜250° C. When the melting point is less than 175° C., hardeness may increase, brittleness may increase, the melting point may decrease, and luster may be reduced. When the melting point is larger than 250° C., stress may be applied to an electronic component due to high-heat.

The solder powder according to an embodiment of the present invention may include alloys of a plurality of kinds. The particle size of the solder powder may be 0.2 μm˜50 μm, and more preferably, 5˜15 μm. When the particle size is less than 0.2 μm, it may be difficult to achieve a fine pitch of an electronic device and to manufacture the alloy powder. When the particle size is larger than 50 μm, it may be difficult to manufacture a bump at the fine pitch of the electronic device since the particle size is large. Here, the particle size may be closely related to the pitch of the printed pattern. As the pitch increases, the particle size may increase.

Even though the each particle size of the solder powders is slightly different, the size of the most solder powders can be defined as the particle size of the solder powders. The solder powder may have a sphere shape, or a shape of a needle and a flake shape. Even though the solder powders generally have the sphere shape, when each particle does not have the complete sphere shape, the particle size is defined as an average of the longest and shortest segments of the line penetrating the particle. As the particle is the almost sphere, the particle size becomes close to a diameter of the sphere.

The binder of the solder ink according to an embodiment of the present invention provides printing property to the solder ink and enhances soldering property of the solder ink.

That is, when using the binder used for the conventional conductive ink (such as a silver ink or a ceramic ink) that dost not have the soldering property, the sufficient soldering property cannot be secured. Thus, problems (such as, voids, bridges, solder balls, slump, wettability on a cupper plate, ion migration) may be induced. Also, when using the binder used for a letterpress printing, elongation (tack) is not good. Accordingly, in the solder ink where an amount of the solder powder is 10 times or over 10 times an amount of pigment for a toning agent, the printing property of the solder ink may be not secured. Therefore, in the embodiment, the binder securing both of the printing property and the soldering property is used.

The binder may preferably include a first resin and a second resin. However, the binder only including the first resin is not excluded.

The rosin resin and the rosin modified resin may be used for the first resin. For the first resin, at least one material of gum rosin, rosin esters, polymerized rosin esters, hydrogenated rosin esters, disproportionated rosin esters, dibasic acid modified rosin esters, rosin modified phenol resin, phenol modified rosin esters, terpenephenolic copolymer resin, maleic anhydride modified resin, and hydrogenated acryl modified resin may be used. Preferably, the rosin modified phenol resin may be used for the first resin.

The rosin resin is a natural resin formed by distilling pine resin and has resin acids. That is, the rosin includes an abietic acid as a main material, and includes a neoabietic acid, a levopimaric acid, a hydroabietic acid, a pimaric acid, a dextro-pimaric acid, and so on. The resin acids included in the rosin resin reduces the oxidized metal on a surface of a component to be adhered, and the adhesive force and the tenacity (toughness) of the solder ink are enhanced by increasing wettability of the melted solder ink. Accordingly, the electrical property of the solder ink can be enhanced. Also, because the rosin resin protects the surface of the component after the soldering, lifetime of an electronic apparatus can be extended.

That is, it is estimated that the first resin performs a fundamental function enhancing the soldering property of the solder bump manufactured by using the solder powder.

Accordingly, the solder ink has superior properties. That is, the solder ink can have high resistance against an organic solvent, corrosion, high-heat or physical impacts from the outside.

For the second resin, urethane based resin, acryl based resin, phenol based resin, vinyl based resin, cellulose based resin, alkyd based resin, ester based resin, and a polymer thereof may be used. Particularly, as the urethane based resin, polyester polyol that is a prepolymer of polyurethane may be preferably used. The second resin increases elongation of the solder ink. Also, it is estimated the second resin secures releasing property from a blanket during a printing process (for example, a gravure offset process), and the transfer can be facilitated to have good properties in the printing by the second resin. It is preferable that the resin having high molecular weight may be used for the second resin.

On the other hand, a solvent, a curing agent, an active agent, a tackifier, a thixotropic agent, a thickening agent, etc may be additionally used for additives.

As the solvent, a first solvent or a second solvent may be used. It is preferable that both of the first solvent and the second solvent may be included in order to manufacture a high-quality solder ink. However, the terms of the first solvent and the second solvent are used for convenience. According to the present invention, at least one solvent of the first solvent and the second solvent is included.

The first solvent is defined as a solvent suitable for dissolving the first resin. When the soldering property is an important issue, the first solvent is used more. Particular, at least one material selected from the group consisting of glycidyl ethers, glycol ethers (for example, 2-Ethoxyethyl acetate (EEA), propylene glycol methyl ether acetate (PGMEA)), vegetable oil (drying oil, or non-draying oil:soybean oil, linseed oil, castor oil, and so on) may be used for the first solvent.

The second solvent is defines as a solvent suitable for dissolving the second resin. When the printing property in the printing process is an important issue, the second solvent is used more. For example, alpha-terpineol or N-methyl-2-pyrrolidone (NMP) may be used.

As the curing agent, an amine curing agent, an acid anhydride-based curing agent, an amid curing agent, an imidazole curing agent, a latent curing agent, a curing accelerator, and so on may be used. Particularly, as the latent curing agent, dicyandiamide, 3-(3,4-dichlorophenyl)-1,1-dimethylurea, 2-phenyl-4-methyl-5-hydroxymethylimidazole, an amine adduct-based compound, a dehydride compound, an onium salt (a sulfonium salt, a phosphonium salt, and so on), or an active ester of biphenylether block carboxylic acid or polyvalent carboxylic acid may be used. The curing accelerator accelerates the curing of the curing agent. The curing accelerator may be added for reducing the curing temperature, thereby adjusting the curing velocity.

For the active agent, at least one material of a lauric acid, memtetrahydrophthalic anhydride, a succinic acid, an adipic acid, a palmitic acid, a 3-boronfluoride ethyl amide complex, butylamine hydrobromide, butylamine hydrochloride, ethylamine hydrobromide, pyridine hydrobromide, cyclohexylamine hydrobromide, ethylamine hydrochloride, 1,3-diphenyl guanidine hydrobromide, a 2,2-bishydroxymethyl propionic acid salt, and 2,3-dibromo-1-propanol may be used. The active agent supports the function of the abietic acid and activates the same. The abietic acid that is the main material of the rosin resin assists the solder powder in melting and becoming a liquid so that the soldering can be easily performed. Also, the abietic acid eliminates (cleans) a oxidation film formed on a copper plate of the substrate surface of the electronic device with almost no tolerance, and thus, the solder ink can be properly adhered to the substrate surface of the electronic device.

The thixotropic agent is for enhancing the printing property. The thixotropic agent improves wetting property, wettability, and thixotropy, thereby enabling the adhesive being coated smoothly and being hardened quickly. As the thixotropic agent, hydrogenated cast wax, polyamide wax, polyolefin wax, a dimer acid, a monomer acid, polyester modified polydimethyl siloxane, a polyaminamide carboxylic acid salt, carnauba wax, colloidal silica, and a bentonite-based clay may be used. The thickening agent is a material used for increasing viscosity. As the thickening agent, ethyl cellulose or hydropropyl cellulose may be used.

For the tackifier, a petroleum-based material, a coumarone-based material, a terpene-based material, and/or rosin derivates may be used. The tackifier may be added to increase the adhesive force and the elongation (tack). Here, C9 may be preferably used for the petroleum-based material, and rosin ester may preferably used for the rosin-based material.

Here, the solder powder may be preferably included by 70˜90 wt %. When the wt % of the solder powder is less than 70 wt %, resistance may increase and electrical property may be deteriorated, although the printing property and the adhesive force are improved. When the wt % of the solder powder is larger than 90 wt %, the printing property may be deteriorated, although the electrical property of the solder bump is improved.

The binder may be preferably included by 3˜10 wt %. When it is beyond the range, the generated problems are different according to wt % of the each of the resins. Generally, when the wt % of the binder is less than 3 wt %, the printing property and the soldering property may be not good, and the electrical property may be deteriorated. When the wt % of the binder is larger than 10 wt %, the electrical property may be deteriorated and the adhesive force and the toughness may be increased.

On the other hand, it is preferable that an weight ratio of the first resin:the second resin is 30˜70:70˜30. The ratio of each resin is very important in order to balance the printing property and the soldering property. When it is beyond the range, one of the printing property and the soldering property may be not good.

The solvent may be preferably included by 4˜12 wt %. When the wt % of the solvent is less than 4 wt %, there may be problems (for example, the printing property and the soldering property may be not good, and the viscosity may increase). When the wt % of the solvent is larger than 12 wt %, the soldering property, the flowability, the adhesive force, and the electrical property may be reduced.

On the other hand, when both of the first solvent and the second solvent are used, the weight ratio of the first solvent:the second solvent may be preferably 50:70˜30˜50. The ratio of each solvent is very important in order to balance the printing property and the soldering property, as in the resin. When it is beyond the range, one of the printing property and the soldering property may be not good.

On the other hand, the solder ink may have a viscosity of 30˜200 Kcps, and preferably, 50˜120 Kcps. When the viscosity is less than 50 Kcps, the flowability, the soldering property, the transferring property, the adhesive force, and the toughness may be deteriorated. When the viscosity is larger than 120 Kcps, the printing property and the transferring property may be deteriorated.

Also, the thixotropic property (index) of the solder ink may be preferable 2.0˜6.0. When it is less than 2.0, there may be problems with the flowability and the printing property. When it is larger than 6.0, the blanket roll may be contaminated and the printing property may be deteriorated.

Manufacture of Solder Ink

### Embodiment 1

5.0 wt % of rosin modified phenol resin was added, heated to 150° C., was dissolved by using 5.5 wt % of linseed oil. 3.5 wt % of rosin ester was dissolved at 80° C. by using 4.0 wt % of a solvent having a molecular weight of 150 or more and a boiling point of 200° C. or more among glycidyl ethers. A Sn—Ag—Cu powder of a particle size of 5˜15 μm was added in the solution to be included by 80 wt %, and a thixotropic agent, a thickening agent, and an active agent were added. Accordingly, a solder ink was manufactured.

### Embodiment 2

4.0 wt % of polyester polyol was used for a second resin, and 7.5 wt % of NMP was used for a second solvent. The second resin was dissolved by using the second solvent. 3.0 wt % of hydrogenated rosin was used for a first resin, and 4.5 wt % of butyldiglycol was used for a first solvent. The first resin dissolved by using the first solvent. A latent curing agent of 3-(3,4-dichlorophenyl)-1,1-dimethylurea as a curing agent, ethylamine hydrobromide, butylamine hydrochloride, and an adipic acid as active agents, triethanolamine(TEA) as a stabilizing agent, hydrogenated cast wax and polyester modified polydimethyl siloxane as thixotropic agents, and ethyl cellulose as a thickening agent were added to the solution, heated, stirred, and dissolved. A Sn—Ag—Cu powder of a particle size of 5˜15 μm was added to the solution to be included by 80 wt %. A solder ink was manufactured.

### Embodiment 3

7.5 wt % of rosin modified phenol resin was used a resin, and 9.0 wt % of BDG (butyldiglycol) was used for a solvent. The resin was added to the solvent, slowly stirred at 120° C., and dissolved. After that, 4-methyl-1,2,3,6-tetrahydrophthalic anhydride as an acid anhydride-based curing agent, ethylamine hydrobromide, butylamine hydrochloride, and an adipic acid as active agents, triethanolamine(TEA) as a stabilizing agent, hydrogenated cast wax and polyester modified polydimethyl siloxane as thixotropic agents, and ethyl cellulose as a thickening agent were added to the solution, heated, stirred, and dissolved. A Sn—Ag—Cu powder of a particle size of 5˜15 μm was added to the solution to be included by 80 wt %. A solder ink was manufactured.

### Embodiment 4

5.8 wt % of acryl resin was used for a second resin, and 3.5 wt % of NMP was used for a second solvent. The second resin was added to the second solvent, heated to 60° C., stirred slowly, and dissolved. 4.2 wt % of hydrogenated rosin was used for a first resin, and was dissolved in 4.5 wt % of BDG as a second solvent at 80° C. After that, 2-phenyl-4-methyl-5-hydroxymethylimidazole as an imidazole curing agent, ethylamine hydrobromide, butylamine hydrochloride, and an adipic acid as active agents, triethanolamine(TEA) as a stabilizing agent, hydrogenated cast wax and polyester modified polydimethyl siloxane as thixotropic agents, and ethyl cellulose as a thickening agent were added to the solution, heated, stirred, and dissolved. A Sn—Ag—Cu powder of a particle size of 5˜15 μm was added to the solution to be included by 80 wt %. A solder ink was manufactured.

### Comparative Example 1

3.0 wt % of polyester polyol was used for a second resin, and 4.5 wt % of NMP was used for a second solvent. The second resin was dissolved at 120° C. with 500 rpm by using the second solvent. 3.0 wt % of hydrogenated rosin was used for a first resin, and 3.0 wt % of butyldiglycol was used for a first solvent. The first resin dissolved by using the first solvent. A latent curing agent of 3-(3,4-dichlorophenyl)-1,1-dimethylurea as a curing agent, ethylamine hydrobromide, butylamine hydrochloride, and an adipic acid as active agents, triethanolamine(TEA) as a stabilizing agent, hydrogenated cast wax and polyester modified polydimethyl siloxane as thixotropic agents, and ethyl cellulose as a thickening agent were added to the solution, heated, stirred, and dissolved. A Sn—Ag—Cu powder of a particle size of 5˜15 μm was added to the solution to be included by 80 wt %. A solder ink was manufactured.

### Comparative Example 2

7.5 wt % of rosin modified phenol resin was used a resin, and 9.0 wt % of BDG (butyldiglycol) was used for a solvent. The resin was added to the solvent, slowly stirred at 120° C., and dissolved. After that, 4-methyl-1,2,3,6-tetrahydrophthalic anhydride as an acid anhydride-based curing agent, triethanolamine(TEA) as a stabilizing agent, hydrogenated cast wax and polyester modified polydimethyl siloxane as thixotropic agents, and ethyl cellulose as a thickening agent were added to the solution, heated, stirred, and dissolved. A Sn—Ag—Cu powder of a particle size of 5˜15 μm was added to the solution to be included by 80 wt %. A solder ink was manufactured.

### Comparative Example 3

7.5 wt % of rosin modified phenol resin was used a resin, and 9.0 wt % of BDG (butyldiglycol) was used for a solvent. The resin was added to the solvent, slowly stirred at 120° C., and dissolved. After that, 4-methyl-1,2,3,6-tetrahydrophthalic anhydride as an acid anhydride-based curing agent, ethylamine hydrobromide, butylamine hydrochloride, and an adipic acid as active agents, triethanolamine(TEA) as a stabilizing agent, and ethyl cellulose as a thickening agent were added to the solution, heated, stirred, and dissolved. A Sn—Ag—Cu powder of a particle size of 5˜15 μm was added to the solution to be included by 80 wt %. A solder ink was manufactured.

Printing of Solder Ink

### Experimental Embodiment 1

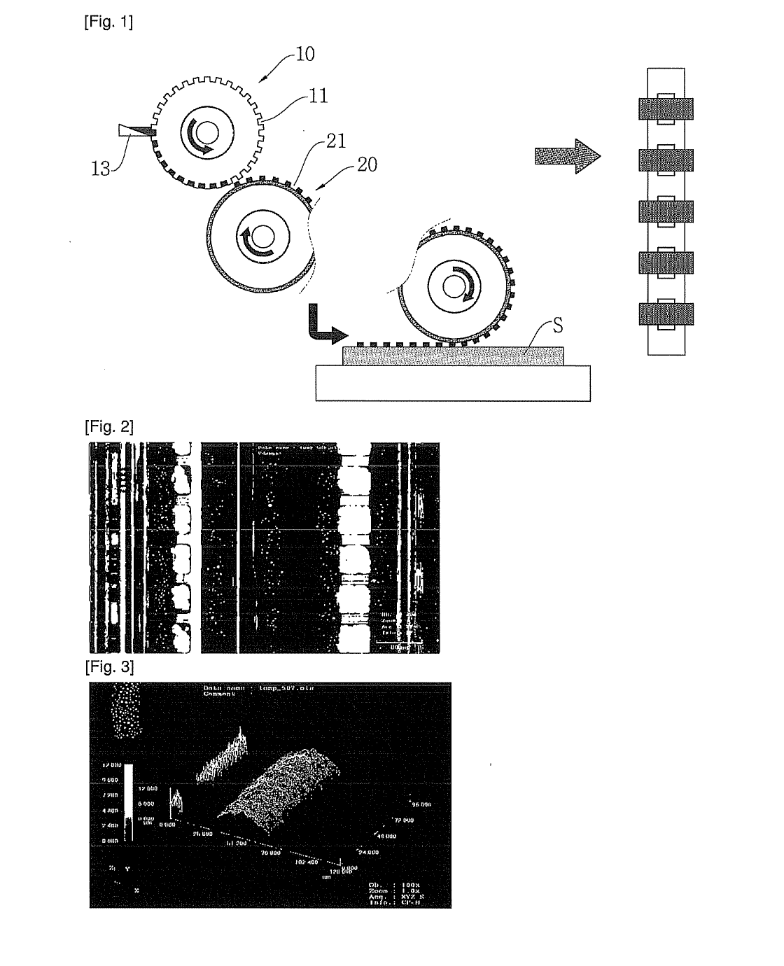

The solder ink having a viscosity of 113 Kcps and thixo of 4.1 manufactured by Embodiment 3 was printed by using a gravure offset apparatus. FIG. 1 is a diagram for illustrating the printing process. According this, the gravure offset apparatus includes a gravure roll 10 and an offset roll 20. First, a solder ink 1 was filled into an intaglio groove 11 of the gravure roll 10 by using a doctor blade 13, and the solder ink of the gravure roll was transferred to a blanket 21 having a planar shape of the offset roll 20. The blanket 21 consisted of polydimethyl siloxane, and absorbed a part of the solvent of the solder ink and printed the solder ink on a substrate S. The printed solder ink penetrated through a reflow oven, and a solder bump was formed.

FIG. 2 is an enlarged photograph of the printed pattern according to Embodiments 3, and FIG. 3 is a three-dimensional photograph of the printed pattern of FIG. 2. It can be seen that a width of the printed pattern was about 50 μm and the printing property was very good.

### Experimental Embodiment 2

Viscosity, elongation (tack), printing property, and soldering property of the solder inks according to Embodiments 1 to 4, and Comparative Examples 1 to 3 were measured, and the results are shown in Table 1.

TABLE 1

| | | | | | Comparative | Comparative | Comparative |
|---|---|---|---|---|---|---|---|
| Items | Embodiment 1 | Embodiment 2 | Embodiment 3 | Embodiment 4 | Example 1 | Example 2 | Example 3 |
| Viscosity | 78 | 113 | 84 | 82 | 132 | 84 | 84 |
| Thixo | 5.5 | 4.1 | 5.8 | 5.1 | 6.8 | 5.8 | 5.8 |
| (index) | | | | | | | |
| Printing | normal | very | good | good | poor | good | poor |
| Property | | good | | | | | |
| Soldering | very | good | normal | normal | good | poor | poor |
| Property | good | | | | | | |

In Experimental Embodiment 2, the printing property was evaluated by measuring a shape, a height, and an insulation distance of the pattern transferred on the substrate through using the three-dimensional filming. The soldering property was evaluated by measuring bridges, solder ball phenomenon, and void phenomenon of the solder bump of basic reflow profile through a SMP scope after soldering.

1. A solder ink, wherein the solar ink being printed by a continuous printing method, comprising:
a solder powder comprising an alloy comprising tin (Sn);
a binder comprising a first resin comprising rosin resin or rosin modified resin;
an active agent; and
a solvent.

2. The solder ink according to claim 1, wherein the first resin comprises at least one material selected from the group consisting of gum rosin, rosin esters, polymerized rosin esters, hydrogenated rosin esters, disproportionated rosin esters, dibasic acid modified rosin esters, rosin modified phenol resin, phenol modified rosin esters, terpenephenolic copolymer resin, maleic anhydride modified resin, and hydrogenated acryl modified resin.

3. The solder ink according to claim 1, wherein the binder further comprises a second resin comprising at least one material selected from the group consisting of urethane based resin, acryl based resin, phenol based resin, vinyl based resin, cellulose base resin, alkyd based resin, ester based resin, and a polymer thereof.

4. The solder ink according to claim 1, wherein the active agent comprises at least one material selected from the group consisting of a lauric acid, memtetrahydrophthalic anhydride, a succinic acid, an adipic acid, a palmitic acid, a 3-boronfluoride ethyl amide complex, butylamine hydrobromide, butylamine hydrochloride, ethylamine hydrobromide, pyridine hydrobromide, cyclohexylamine hydrobromide, ethylamine hydrochloride, 1,3-diphenyl guanidine hydrobromide, 2,2-bishydroxymethyl propionic acid salt, and 2,3-dibromo-1-propanol.

5. The solder ink according to claim 3, further comprising a thixotropic agent,
wherein the thixotropic agent comprises at least one material selected from the group consisting of hydrogenated cast wax, polyamide wax, polyolefin wax, a dimer acid, a monomer acid, polyester modified polydimethyl siloxane, a polyaminamide carboxylic acid salt, carnauba wax, colloidal silica, and a bentonite-based clay.

6. The solder ink according to claim 1, wherein the solvent comprises at least one material selected from the group consisting of clycidyl ethers, glycol ethers, vegetable oil, alpha-terpineol, and N-methyl-2-pyrrolidone(NMP).

7. The solder ink according to claim 1, further comprising a curing agent, a tackifier, and a thickening agent.

8. The solder ink according to claim 3, wherein the first resin comprises rosin modified phenol resin.

9. The solder ink according to claim 8, wherein the second resin comprises polyester polyol.

10. The solder ink according to claim 1, wherein the solder powder has a melting point of 130˜300° C.

11. The solder ink according to claim 9, wherein the solder powder comprises the alloy comprising the Sn and at least one material selected from the group consisting of Ag, Cu, Bi, Zn, In, and Pb.

12. The solder ink according to claim 1, wherein the solder powder is included by 70˜90 wt %, the binder is included by 3˜10 wt %, and the solvent is included by 4˜12 wt %.

13. The solder ink according to claim 3, wherein the weight ratio of the first resin of the binder:the second resin of the binder is 30˜70:70˜30.

14. The solder ink according to claim 1, wherein the solder powder has a particle size of 0.2 μm˜50 μm.

15. The solder ink according to claim 1, wherein the solder ink is used in a roll-to-roll process where a flexible substrate is continuously supplied, and
wherein the roll-to-toll process uses one or more of a roll screen printing method, a gravure printing method, a flexo printing method, an inkjet printing, an offset printing method, and a gravure offset printing method.

16. The solder ink according to claim 1, the solder ink has a viscosity of 30˜200 Kcps.

17. The solder ink according to claim 1, wherein the solder ink is printed on a metal, a glass, a plastic, a flexible printed circuit board, or a silicon wafer.

18. An electronic device according to claim 17, wherein the electronic device package is a chip size package or a wafer level package.

19. An electronic apparatus comprising the electronic device package according to claim 18.

20. The electronic apparatus according to claim 19, wherein the electronic apparatus is one apparatus selected from the group consisting of a liquid crystal display panel, a plasma display panel, a touch screen, a flexible liquid crystal display panel, a flexible organic light emitting diode panel, a solar cell, a radio frequency identification, a flexible conductive film, a polymer transistor, and an electronic book.
